(19) United States
(12) Patent Application Publication
(10) Pub. No.: US 2019/0286988 A1
(43) Pub. Date: Sep. 19, 2019

(54) FEATURE-BASED SELECTIVE CONTROL OF A NEURAL NETWORK

(71) Applicant: ANTS TECHNOLOGY (HK) LIMITED, WANCHAI (HK)

(72) Inventors: Gal PERETS, Mazkeret Batya (IL); Assaf ARBELLE, Beer-Sheva (IL); Ron FRIDENTAL, Shoham (IL); Mica Arie NACHIMSON, Givat-Brener (IL)

(21) Appl. No.: 15/921,737

(22) Filed: Mar. 15, 2018

(51) Int. Cl. G06N 3/08; G06N 3/04; G06K 9/62; G06F 9/451

(52) U.S. Cl. CPC G06N 3/082; G06F 9/451; G06K 9/62; G06N 3/04

(57) ABSTRACT

A method of controlling output of a neural network, the method including receiving or training the neural network; wherein the neural network is an application executed on a computer that receives input from sensors and provides an output comprising predictions and/or decisions based on the input, identifying a region of the neural network that contains information of interest, finding within the identified region a specific node or group of nodes that contains specific information of interest; and applying a manipulation application external to the neural network to operate on and alter the output of the specific node or group of nodes within the neural network; wherein the altered output of the specific node affects the output of the neural network without altering the input of the neural network.

### BACKGROUND

Predictive neural networks are commonly used for predicting future states of a system and taking decisions based on the predictions. A predictive neural network is usually configured to receive as input a series or sub-series of data units and to generate based on the input predictive information, which predicts information about a successive data unit or units. Such a network is described, for example, in Lotter et al. “Deep Predictive Coding Networks for Video Prediction and Unsupervised Learning” (arXiv:1605.08104v5).

Known image and video processing tools usually utilize static image frames for analysis of the image, comparison, identification of objects and manipulation of the image data. Such tools, when they use machine learning techniques, apply pre-trained neural networks trained to identify specific types of objects defined in advance. Therefore, such systems are very limited and inflexible.

### SUMMARY

According to an aspect of an embodiment of the disclosure, there is provided a method for generating an alternative output of a neural network, the method including: identifying a region of the neural network that handles information of interest, finding specific nodes that control specific parameters of the neural network, installing external switches or an external application to manipulate the specific nodes to selectively operate on nodes of the identified region.

There is thus provided according to an exemplary embodiment of the disclosure, a method of controlling output of a neural network, the method comprising:

receiving or training the neural network; wherein the neural network is an application executed on a computer that receives input from sensors and provides an output comprising predictions and/or decisions based on the input;

Identifying a region of the neural network that contains information of interest;

finding within the identified region a specific node or group of nodes that contain specific information of interest; and

applying a manipulation application external to the neural network to operate on and alter the output of the specific node or group of nodes within the neural network; wherein the altered output of the specific node affects the output of the neural network without altering the input of the neural network.

In an exemplary embodiment of the disclosure, identifying a region comprises: obtaining data from a plurality of locations in the neural network, while the neural network is processing an input data stream from the sensors; and analyzing relevance of the data. Optionally, the method further comprises receiving instructions via a communication network and/or user interface and based on the instructions dynamically identifying the region of the neural network that contains information of interest. In an exemplary embodiment of the disclosure, operating on includes extracting information from the specific node or group of nodes. Alternatively or additionally, operating on includes changing, replacing, or otherwise controlling the mathematical operators executed in the nodes.

In an exemplary embodiment of the disclosure, the method further comprises operating on a combination of found nodes to extract information from or manipulate elements with a certain combination of properties. Optionally, the operation for operating on is selected from the group consisting of: motion manipulation, object removal, frequency change, image filling, and color manipulation. In an exemplary embodiment of the disclosure, the method further comprises generating multiple instances of the identified region and selectively controlling the instances to obtain a desired output. Optionally, operating on comprises calculating a gradient for each node representing the requirement for altering activity of the node to obtain a desired output of the neural network and applying the calculated gradients on the nodes. Alternatively or additionally, operating on comprises setting a desired value in a specific node.

In an exemplary embodiment of the disclosure, a node is implemented by an electronic circuit with a forget gate deciding whether to keep or forget history information and operating on comprises changing activation of the forget gate.

There is further provided according to an exemplary embodiment of the disclosure, a system for generating an alternative output of a neural network, the system:

a computer including a processor and memory;

one or more sensors for providing a data stream as input to the computer;

a neural network application; wherein the neural network application receives the input from the sensors and provides an output comprising predictions and/or decisions based on the input;

a manipulation application external to the neural network application; wherein the manipulation application is configured to perform:

identifying a region of the neural network that contains information of interest; finding within the identified region a specific node or group of nodes that contain specific information of interest; and operating on and altering the output of the specific node or group of nodes within the neural network; wherein the altered output of the specific node affects the output of the neural network without altering the input of the neural network.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a system for selective control of a predictive neural network, according to some embodiments of the present disclosure;

FIG. 2 is a schematic more detailed illustration of an exemplary predictive neural network, according to some embodiments of the present disclosure;

FIG. 3 is a flow diagram of a method for selecting a network portion of interest, according to some embodiments of the present disclosure;

FIG. 4 is a schematic illustration of an exemplary network node, according to some embodiments of the present disclosure;

FIG. 5A is a schematic illustration of image analysis of a mirror-duplicated video frame, and processed images, according to some embodiments of the present disclosure;

FIG. 5B is an example of actual images processed as explained regarding FIG. 5A, according to some embodiments of the present disclosure; and

FIG. 5C is a schematic illustration of data classification diagrams presenting separation that may be calculate by the processor, of information generated in a specific portion of the network, according to some embodiments of the present disclosure.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

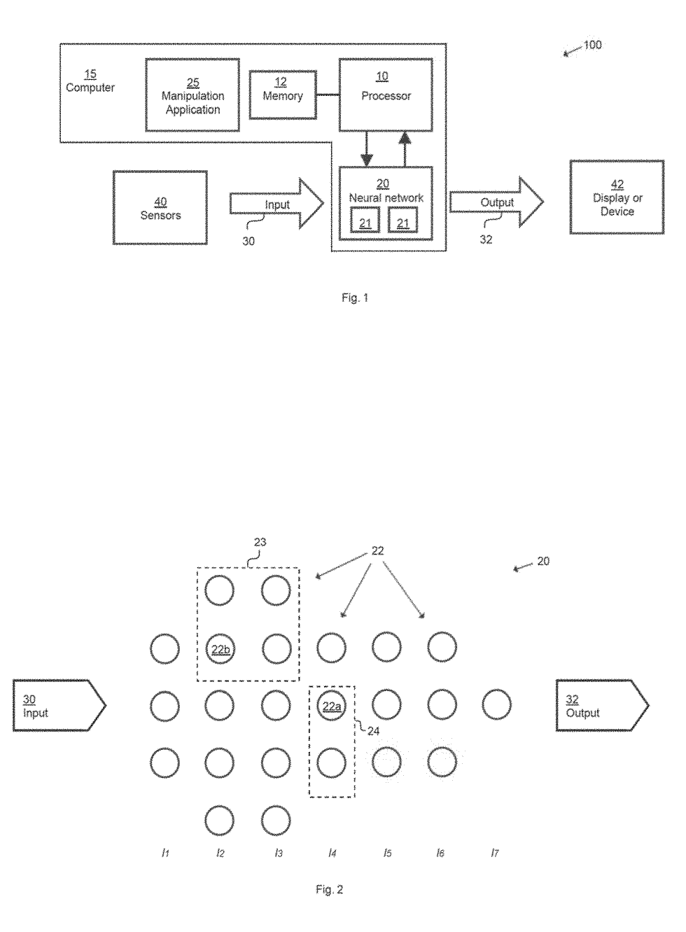

FIG. 1 is a schematic illustration of a system 100 for selective control of a predictive neural network 20, according to some embodiments of the present disclosure. According to some embodiments of the present disclosure, there is provided a system 100 and method for selective control of the neural network 20. The provided system 100 may receive as input 30 a data stream such as video or audio stream from a camera/sensor 40 or other types of serial data from sensors 40 (e.g. a camera, radar, volume detector and/or other detectors). The data is processed by the neural network 20, for example by a neural network 20 that encodes predictive data in various regions 21 of the network. For example, the neural network 20 may generate, calculate or include in various regions 21 a prediction for a certain time in the future, e.g. predicts a future video frame, motion or sound responsive to the input 30.

According to some embodiments of the present disclosure, a solution is provided for flexible and adjustable manipulation of data without manipulating the input 30 or output 32 of the neural network 20. This is provided by detecting, by the control system 100, a particular region 21 or group of nodes 22 in the neural network 20 that controls certain information of interest, for example wherein the region 21 handles a certain aspect of the input 30, such as determining and/or analyzing movement of a certain object, a periodic occurrence of an event, depth information, division of objects to types or groups, determining characteristic of a certain object etc. In some embodiment, the detected region 21 has been trained to generate optimal predictions about the information of interest. Accordingly, the provided control system 100 may extract specific information from the input 30 by the neural network 20. In some embodiments of the disclosure, the control system 100 may be configured to detect a certain occurrence or property in the input 30 and to manipulate the prediction result by interfering with this occurrence or property, for example by distorting or replacing the input or output of a region 21 or a particular node 22 of the neural network 20 with other data.

In an exemplary embodiment of the disclosure, the provided control system 100 may identify and alter specific features resulting from a data set or stream provided by input 30. For example, the control system 100 may detect in the neural network 20 nodes or groups of nodes that process the direction of motion of people in video data, for example identifying people that go left. Then, the control system 100 may instruct the nodes of the region 21 to change the movement direction of these specific people that are going left. Additionally, in a neural network 20 that receives video data from a security camera (camera/sensor 40) installed in a bathroom, the control system 100 may identify portions with image data of a human body and manipulate the nodes of the region 21 to cover the body in the output 32, to keep the privacy of a person. In another example, the provided control system 100 may identify image corruptions and damages and correct them before providing output 32. In a further example, the control system 100 may replace, hide, blur, and make elements of an image disappear, or perform hole-filling in an image, by identifying responsible regions in the neural network 20 and manipulating these regions.

In some embodiments of the disclosure, neural network 20 is implemented as an application on a computer 15 having a processor 10 and memory 12. Optionally, the output 32 of the neural network 20 is provided to a display/device 42, for example to provide images for a user to review or to manipulate a device that performs a specific physical task. Optionally, computer 15 also executes a manipulation application 25 that may interact with a user enabling the user to provide instructions to manipulate specific nodes 22 or regions 21 of neural network 20.

Alternatively or additionally, computer 15 may be connected to a communication network (not shown) and enable manipulation of nodes 22 directly from a remote computer (e.g. a computer that is distinct from the computer executing the neural network 20.

In an exemplary embodiment of the disclosure, by enabling adjustable image manipulation, some embodiments of the present disclosure may provide flexible and dynamic multi-optional control, which may enable a user to decide on-the-spot how to manipulate an image to generate a different output.

In some embodiments of the present disclosure, identification of a neural network 20 portion that records a frequency signal may enable the control system to identify life signals in humans and animals, or to change a scene lighting color and/or brightness.

In some embodiments of the present disclosure, neural network 20 is configured or trained to receive as input 30 a series or sub-series of data units and to generate output 32, based on this input. The output 32 may include predictive information, which predicts a successive data unit or units in a series in continuation of the information from input 30. For example, in a video stream input, a data unit may be a single frame of a future image. Such a neural network 20 is described, for example, in Lotter et al. “Deep Predictive Coding Networks for Video Prediction and Unsupervised Learning” (arXiv:1605.08104v5). However, the disclosure is not limited to a specific kind of neural network 20 and can be performed, with any suitable kind of neural network 20.

Accordingly, neural network 20 may receive the input stream 30, for example a video stream or any other suitable kind of stream of serial data units. In some embodiments, input stream 30 is a certain segment or a sub-stream of a longer data stream. Neural network 20 processes input stream 30 and generate output 32. In some embodiments, output 32 includes processed information about the data unit(s) or a potential or actual successive data unit(s) of the stream. For example, output 32 may include a predicted successive data unit or a predicted series of successive data units. In the process of generating the output, network 20 may acquire information about different aspects of the input data units. In some cases, the acquired information may include how different aspects of the data change from one data unit to the next one. In some embodiments, information about different aspects of the data is obtained by unsupervised learning, i.e. without a preliminary dataset.

Memory 12 may include a tangible non-transitory computer readable storage medium (or media), having computer readable program instructions thereon. For example, execution of the instructions by processor 10 causes processor 10 to carry out the methods and steps described herein.

Reference is now made to FIG. 2, which is a schematic more detailed illustration of an exemplary neural network 20, according to some embodiments of the present disclosure. For example, neural network 20 may include a plurality of nodes 22 in a series of groups or layers lₗ-lₙ. In some embodiments, a node 22 may receive data input, for example from the nodes of a previous layer, in known time intervals, and generate information, decisions and/or predict the input received next, i.e. in the next time interval, for example by unsupervised or partially supervised learning.

In some embodiments of the present disclosure, processor 10 may analyze operations of neural network 20 during the prediction process, to identify a relevant portion of network 20 that is likely to generate information of interest, for example about a certain aspect of the input data. For example, portion 23 may be a region 21 that is a layer of the neural network 20, a group of layers or a group of nodes 22. Based on the analysis, processor 10 may identify the neural network architecture and various activities such as information flow and mathematical operations in various portions of network 20. As described in more detail herein below, according to some embodiments of the present disclosure, after identifying a desired portion, processor 10 may find within the identified portion specific relevant neurons (nodes 22) and/or groups of neurons (nodes 22) that generate information of interest. In some embodiments, as described herein, the specific nodes 22 or groups 23 may be found by calculating a projection of the identified neural network portion on a parameter subspace relevant to the information of interest.

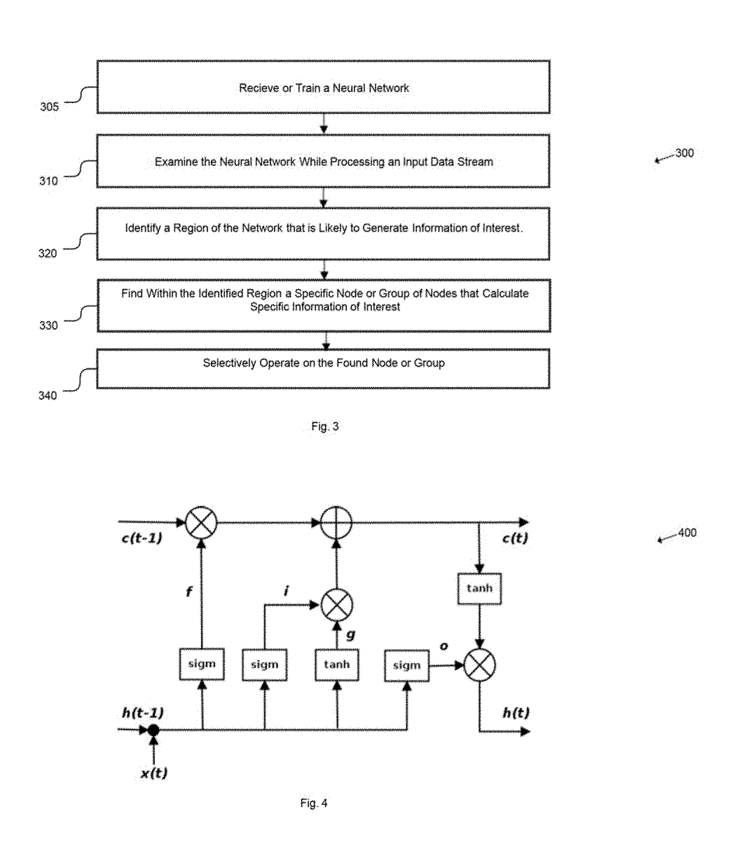

Reference is now made to FIG. 3, which is a flow diagram of a method 300 for selecting a network portion of interest, according to some embodiments of the present disclosure. Initially a neural network 20 is received or trained (305) to accept input 30 and provide output 32. As indicated in (310), processor 10 (FIG. 1) may examine neural network 20 while processing input data stream 30. For example, processor 10 may receive and analyze information from various nodes 22 (FIG. 2) in network 20. Optionally, processor 10 may identify particular mathematical operations performed in these nodes. For example, processor 10 may identify (320) how or which information passes between nodes 22 or changes in various portions/regions of network 20. Optionally, processor 10 may identify (320), based on the analyzed information, a region 21 of network 20 that is likely to generate information of interest. For example, processor 10 may decide, e.g. by calculation or received instruction, or be instructed which network regions 21 are relevant and which are not according to mathematical limits. For example, the encoding capabilities of a certain network region 21 should match the characteristics of the information of interest. Optionally, processor 10 may decide that a node 22 that generates a prediction for a certain object of interest (like a cat, or a phone), is not located at the first or second convolution layers l₁, l₂. In an exemplary embodiment of the disclosure, the first one or two layers calculate low-level features while the object of interest is represented by a high-level feature, for example the higher level may be a combination of low-level features. For example, processor 10 may calculate that the image area processed by a certain node 22 in a certain layer lᵢ, e.g. the receptive field of the certain node 22, is too small or too big for the object of interest.

Another example is described with reference to FIG. 4, which is a schematic illustration of an exemplary network node 400, according to some embodiments of the present disclosure. Network Node 400 may include a Long-Short Term Memory (“LSTM”) block, including a forget gate f deciding whether to keep or forget history information c(t−1), input gate i×g (the product of i and g), and output gate o. The product of t and g is added to the decision of the forget gate. In some embodiments, processor 10 may decide, e.g. calculate or be instructed, that motion vector information is not generated in the forget gate f, but in the input gate i×g, because of the type of calculation performed in this portion of the LSTM block.

As indicated in block 330, processor 10 may find within the identified region 21 a specific node 22 or group of nodes that calculate specific information of interest. For example, in order to find the specific nodes, processor 10 projects the identified region on a parameter subspace that corresponds to the information of interest, for example by extracting the errors in the corresponding parameters and optimizing a suitable cost function.

For example, processor 10 may look for a region 21 of neural network 20 that predicts motion of a certain object, for example, region 23. Alternatively or additionally, processor 10 may look for a region 21 of neural network 20 that predicts a certain periodic event, for example region 24. In order to find a specific node 22 or specific nodes 22 that predict motion of an object, processor 10 may extract from the nodes 22 in region 23 the errors in the velocity and acceleration parameters. Similarly, to find a specific node 22 or specific nodes 22 that predict a periodic event, processor 10 may extract from the nodes 22 in region 24 the errors in the frequency and phase parameters. Then, processor 10 may optimize a cost function to find the node(s) 22, for example node 22a, where the errors in these parameters are minimal, which are most probably the nodes 22 that are used for predicting information about these parameters.

In some embodiments of the present disclosure, once processor 10 recognizes potential relevant regions of network 20, processor 10 applies an unsupervised dimensional reduction method such as, for example, Principal Component Analysis (PCA) or t-Distributed Stochastic Neighbor Embedding (t-SNE) on the operations of these regions, to find clues to the information of interest.

Accordingly, processor 10 may be configured, e.g. pre-configured and/or receive instructions via a communication network and/or user interface, to find a node 22 or group of nodes 22a of neural network 20 that contains information and/or calculates a prediction for a certain property in the data stream, e.g. the node 22 or group of nodes 22 applies a certain mathematical operator on the input of node 22a.

Additionally, in some embodiments of the present disclosure, processor 10 may extract specific information from the relevant nodes 22 of network 20. For example, processor 10 may obtain information about certain objects in a video frame such as motion, color change, frequency, rotation and/or any other suitable data for various applications. For example, processor 10 may obtain information about the camera capturing the frames and/or the camera operator.

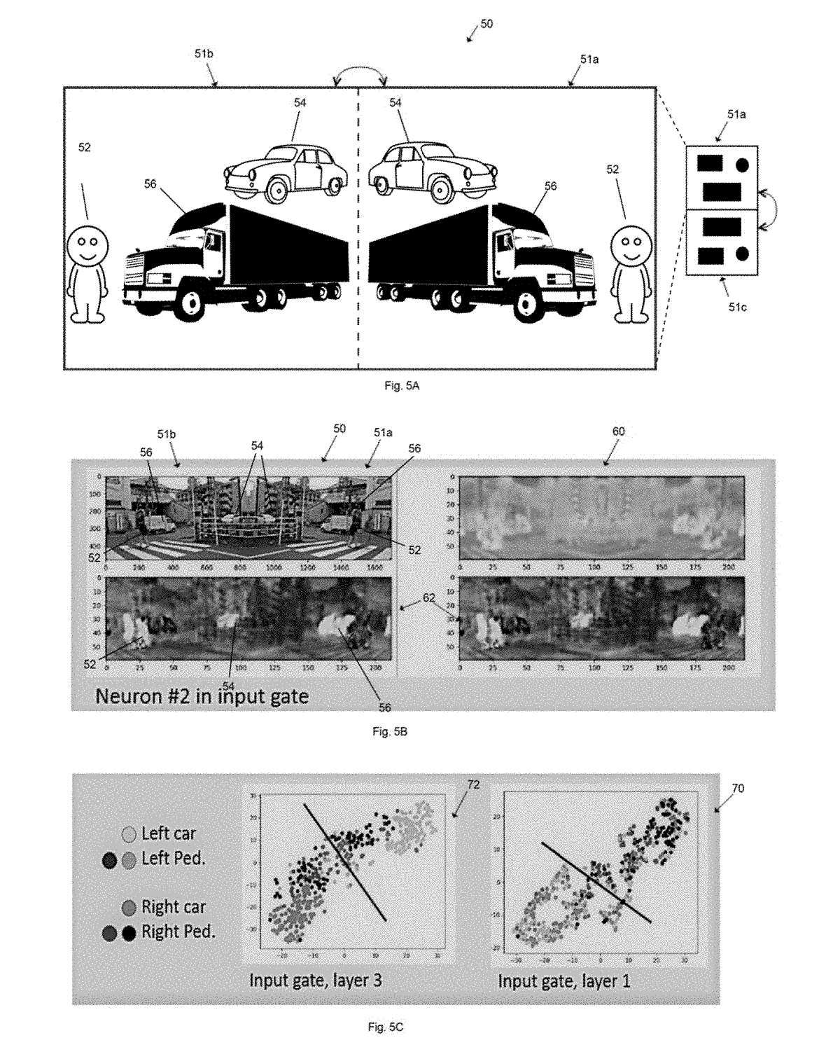

In an exemplary embodiment of the disclosure, controlling the nodes 22 of the neural network 20 allows independent manipulation of objects of an image. Reference is now made to FIG. 5A, which is a schematic illustration of a manipulation of an image, according to an exemplary embodiment of the disclosure. Optionally, each object/element and its characteristics may be controlled. For example frame 50 includes an image 51b with elements: car 54, truck 56 and person 52, which were identified by nodes 22 of neural network 20. Frame 50 also includes a horizontally flipped (mirror) image 51b, which is formed by manipulation application 25 with processor 10 by flipping the individual elements to generate an image 51b with horizontally flipped elements. Likewise 51c represents a schematic illustration of vertically flipped elements. The flipped image 51b can be represented by x2=−x1 and y2=y1 as the coordinates for each pixel, wherein x1 and y1 are the coordinates of the same pixel in the original image 51a.

FIG. 5B is an example of actual images processed as explained above regarding FIG. 5A. Frame 50 includes images 51a and 51b, which are horizontally flipped images so that an object that moves left in image 51a will move right in image 51b, and vice versa.

It should be noted that manipulation of nodes 22 can allow more advanced manipulations as illustrated by processed images 60, and 62. For example, processor 10 may be configured to identify pedestrians that go left. Each portion of neural network 20 may process a different aspect of video frame 50. For example, images 60, 62 display a segmentation, which marks in white (or blurs) elements moving in a specific direction (e.g. left). Optionally, manipulation application 25 may be used change the motion speed/direction of an element or other characteristics. Optionally, manipulation application 25 may be used to blur an element, cause it to disappear or be replaced by a different element.

In an exemplary embodiment of the disclosure, identification of the regions of interest 21 in neural network 20 may be performed by graphically mapping information from the nodes 22 of neural network 20 while processing an input 30 data stream. Reference is now made to FIG. 5C, which is a schematic illustration of data classification diagrams 70 and 72 presenting a separation that may be calculated by processor 10, of information generated in a specific portion of network 20 based on frame 50, according to some embodiments of the present disclosure. For example, diagram 70 may present separation between different kinds of moving objects, e.g. cars and pedestrians, which may be identified based on the information generated in a specific portion of neural network 20. For example, diagram 72 may present separation between moving objects that go left and moving objects that go right, which may be identified based on the information generated in a specific portion of network 20.

In some embodiments of the present disclosure, once processor 10 observes a relevant separation in the data generated in a certain region of network 20, processor 10 identifies in which specific node 22 (neuron) information of interest is calculated.

As illustrated herein, processor 10 may project the identified region 21 on a parameter subspace that corresponds to the information of interest, for example by extracting the errors in the corresponding parameters and optimizing a suitable cost function. For example, in order to optimize the detection accuracy of the motion direction, processor 10 may look for a region that best fulfills x1=−x2, y1=y2 for frame 50 described herein. Additionally, for a vertically flipped images 51a and 51c the flipped image 51c can be represented by x3=x1 and y3=−y1 as the coordinates for each pixel. Accordingly, processor 10 may look for a region 21 that best fulfills x1=x3, y1=−y3 for frame 50 described herein. For example, processor 10 may minimize the cost function f=x1+x2+y1−y2+x1−x3+y1+y3, wherein all vectors are normalized to unit circle so that the trivial solution x1=x2=x3=y1=y2=y3=0 will not be valid.

As mentioned herein, in some cases processor 10 is configured to identify a region 21 of neural network 20 that contains frequency information, for example of a certain image element. In order to identify the relevant region 21 of neural network 20, processor 10 may require that a specific pixel in a sequence of frames has a repetition frequency of a certain varying property along the series of data units. For example, the repetition is represented by a cosine function:

y(t|A=1)=cos(ωt)

Wherein t is a time assigned to a frame, ω is the frequency(2π), y is the stage or phase, and A is the cosine wave amplitude, which may be normalized to 1. Since the time difference t₂−t₁ between two frames y₁=cos(ωt₁) and y₂=cos(ωt₂) is known, the following cost function f can be used by processor 10:

arcos(y₂)−arcos(y₁)=w(t₂−t₁)

f=arcos(y₂)−arcos(y₁)−welt=0

Accordingly, processor 10 may minimize f during the optimization procedure in order to identify the region 21 of network 20 that includes the minimal value of f, e.g. the region 21 of network 20 that contains the desired frequency information.

As indicated in block 340, application 25 may instruct processor 10 to selectively operate on the found node 22 or group of nodes 22a. For example, processor 10 may be configured to manipulate, change, replace, extract information, or otherwise control the mathematical operators executed in the found node 22a, in order to obtain a certain modified output. For example, the selective operation includes at least one of a list consisting of: motion manipulation, object removal, frequency change, and image hole filling, color manipulation, and/or any other suitable operation. For example, the selective operation is performed by setting a desired value in a specific node 22, changing activation of a forget gate in a specific node, and/or any other suitable manner of performing the selective operation on a specific node.

In some embodiments, manipulation application 25 may instruct processor 10 to identify and manipulate also a second node 22 or group of nodes 22b that calculates prediction for a second property, in order to control elements of the data that fulfill the two properties in combination. Similarly, processor 10 may control a combination of nodes to control elements that fulfill a certain combination of properties. For example, processor 10 may be configured to change, in a certain video stream, the color of a yellow car, which is identified as going south, to red. Alternatively or additionally, processor 10 may calculate a gradient for each node 22 in the identified region 21, the calculated gradients required for altering activity of the identified region to obtain a desired output. Then, processor 10 may apply the calculated gradients on the respective nodes. In some embodiments, processor 10 may generate multiple instances of the identified or selected region of network 20 and selectively control the instances to obtain a desired output.

In some embodiments, processor 10 is dynamically controlled by software instructions to locate nodes that predict specified properties and to extract information and/or manipulate the located nodes according to the instructions. The system and method of the present disclosure enable such dynamic control without being required to set in advance the operations of processor 10 on network 20.

Some embodiments of the present disclosure may include a system, a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method of controlling output of a neural network, the method comprising:
receiving or training the neural network; wherein the neural network is an application executed on a computer that receives input from sensors and provides an output comprising predictions and/or decisions based on the input;
identifying a region of the neural network that contains information of interest;
finding within the identified region a specific node or group of nodes that contain specific information of interest; and
applying a manipulation application external to the neural network to operate on and alter the output of the specific node or group of nodes within the neural network; wherein the altered output of the specific node affects the output of the neural network without altering the input of the neural network.

2. The method of claim 1, wherein identifying a region comprises:
obtaining data from a plurality of locations in the neural network, while the neural network is processing an input data stream from the sensors; and
analyzing relevance of the data.

3. The method of claim 1, comprising receiving instructions via a communication network and/or user interface and based on the instructions dynamically identifying the region of the neural network that contains information of interest.

4. The method of claim 1, wherein operating on includes extracting information from the specific node or group of nodes.

5. The method of claim 1, wherein operating on includes changing, replacing, or otherwise controlling the mathematical operators executed in the nodes.

6. The method of claim 1, comprising operating on a combination of found nodes to extract information from or manipulate elements with a certain combination of properties.

7. The method of claim 1, wherein the operation for operating on is selected from the group consisting of: motion manipulation, object removal, frequency change, image filling, and color manipulation.

8. The method of claim 1, comprising generating multiple instances of the identified region and selectively controlling the instances to obtain a desired output.

9. The method of claim 1, wherein operating on comprises calculating a gradient for each node representing the requirement for altering activity of the node to obtain a desired output of the neural network and applying the calculated gradients on the nodes.

10. The method of claim I, wherein operating on comprises setting a desired value in a specific node.

11. The method of claim 1, wherein a node is implemented by an electronic circuit with a forget gate deciding whether to keep or forget history information and operating on comprises changing activation of the forget gate.

12. A system for generating an alternative output of a neural network, the system comprising:
a computer including a processor and memory;
one or more sensors for providing a data stream as input to the computer;
a neural network application; wherein the neural network application receives the input from the sensors and provides an output comprising predictions and/or decisions based on the input;
a manipulation application external to the neural network application; wherein the manipulation application is configured to perform:
identifying a region of the neural network that contains information of interest; finding within the identified region a specific node or group of nodes that contain specific information of interest; and operating on and altering the output of the specific node or group of nodes within the neural network; wherein the altered output of the specific node affects the output of the neural network without altering the input of the neural network.

13. The system of claim 12, wherein the manipulation application is further configured to:
obtain data from a plurality of locations in the neural network, while the neural network is processing the input data stream; and
identify based on the obtained information a region of the neural network that contains information of interest.

14. The system of claim 12, wherein the manipulation application is further configured to receive instructions via a communication network and/or user interface and based on the instructions dynamically identifying the region of the neural network that contains information of interest.

15. The system of claim 12, wherein operating on includes extracting information from the specific node or group of nodes.

16. The system of claim 12, wherein operating on includes changing, replacing, or otherwise controlling the mathematical operators executed in the nodes.

17. The system of claim 12, wherein the manipulation application is further configured to operate on a combination of found nodes to extract information from or manipulate elements with a certain combination of properties.

18. The system of claim 12, wherein the operation for operating on is selected from the group consisting of: motion manipulation, object removal, frequency change, image filling, and color manipulation.

19. The system of claim 12, wherein the manipulation application is further configured to generate multiple instances of the identified region and selectively control the instances to obtain a desired output.

20. The system of claim 12, wherein a node is implemented by an electronic circuit with a forget gate deciding whether to keep or forget history information and operating on comprises changing activation of the forget gate.
